(19) United States
(12) Patent Application Publication
(10) Pub. No.: US 2010/0006485 A1
(43) Pub. Date: Jan. 14, 2010

(54) WATER FILTRATION FILL STICK

(76) Inventors: Jerry Rademan, Jacksonville, FL (US); Timothy Holmes, Jacksonville, FL (US)

Correspondence Address: HERBERT L. ALLEN;ALLEN, DYER, DOPPELT, MILBRATH & GILCHRIST, P.A., 255 SOUTH ORANGE AVENUE, SUITE 1401, P. O. BOX 3791, ORLANDO, FL, 32802-3791, US

(21) Appl. No.: 12/499,498

(22) Filed: Jul. 8, 2009

Related U.S. Application Data
(63) Continuation of application No. 11/191,664, filed on Jul. 28, 2005, now abandoned.

(51) Int. Cl. B01D 35/153

(52) U.S. Cl. 210/129; 210/234; 210/136

(57) ABSTRACT

This is a device used for purifying water for eventual use in a swimming pool, hot tub, spa or aquarium The water is passed through a tube and purified by means of filtering and/ or ion exchange media, which completely fills the interior of the tube. The choice of filtering and/or ion exchange media is chosen based on a particular need, which is presented by the water source.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

A. Field of the Invention

This device purifies water prior to placing it into a pool, spa, hot tub or aquarium. Primarily by ionic exchange filtration, absorption and adsorption, this device removes the majority of metal ions, inorganic and organic ions, hard minerals, sediment and many other water contaminants, which can stain and cause maintenance headaches for the builder/owner.

B. Prior Art

Other examples for purification of water have been found in the prior art. Examples of the prior art included Crane, U.S. Pat. No. 6,365,044. This device, like others, is not meant to be portable and disposable Another example is Barnes, U.S. Pat. No. 6,342,154, which uses ultraviolet light and ozone to purify water. Like Crane, Barnes is not designed to be portable and disposable and does not remove metal ions.

In addition the prior art does not allow the filtering media to be custom tailored to a particular contaminant in a water source.

### BRIEF SUMMARY OF THE INVENTION

It is absolutely essential that pure water be placed in a pool, spa, hot tub or aquarium to maximize esthetics and comfort of the user and eliminate or reduce the maintenance problems. The primary water contaminants that can cause severe staining to a pool, spa tub or aquarium surface (plaster, marcite, fiberglass, vinyl, etc) are oxidized ions of iron, copper, silver, zinc, magnesium, nickel and many other metals. Also, many water contaminants need to be removed in order to allow maximum effectiveness of typical water algaecides and sanitizers such as chlorine, bromine and several other sanitizers. High levels of phosphates, calcium hardness, nitrates and others are examples of such sanitizer inhibitors that are important to remove from the water during the fill stage.

Great efforts are made to ensure that the water in a pool (as an example) remains pure both for the user of the water as well as for maintenance concerns. Impure water can lead to staining and corrosion of parts which of course leads to expense. Additionally, if the water is cleaner or purer when it is initially used to fill a pool, there will tend to be less maintenance headaches in terms of maintaining the proper water quality.

This device, purifies the water, regardless of the source, prior to entry into a pool, hot tub, aquarium or spa.

The operation of the device does not depend upon the size of the unit-or the source of the water.

It is also a device, which is easily attached and detached by use of standard hose connections and therefore is designed to be portable.

The device is a cylindrical tube, which is filled with a variety of filtering material, which have been proven to be very useful in the purification of water. The media is designed to remove all sediment as well as hard metals such as irons copper and silver, to name a few. The specific. media or combination of media may change depending on the desired contaminate needing removal from the fill water.

One of the principal advantages in purification is the reduction of cost to own a pool, spa or hot tub, etc. The device is comprised of a cylindrical tube into which water flows through the filtering media. Because all the water flows through the media, maximum purification occurs.

At the outlet of the device a diffuser is installed. The purpose of the diffuser is to ensure that the water is not blocked inside the tube causing excessive back pressure and damage to the device. The diffuser also prevents the filtering media from escaping from the device.

The device can be made in different sizes depending on a particular need. Different filtering media may be used to address a particular need, which is found in a particular water source.

In addition the order of each filtration--media is also important in determining maximum filter efficiency, flow rate and metal ion exchange efficiency. Typically the filter media is strategically added placing the larger particle size media filtering agent and the smallest particle sized media filtering agent in a synergistic fashion.

The filtration bed length has also been found to be very important in sufficient removal of certain water contaminants. This bed length will vary based on the desired contaminant removal, but typical bed lengths within the cylindrical device range from one (1) inch to sixty (60) inches. For certain more difficult contaminant removals, attaching two or more fill stick devices in parallel are employed.

Sometimes, an oxidizing agent such as chorine may be added to the bottom chamber of the filter device in order to minimize organic water contaminants such as tannins, lignins and algae.

The device can also be used to filter contaminants from an existing pool, spa, tub or aquarium that is already filled with water. Once a pool plaster surface, for example, has been severely stained by oxidized metals such as iron or copper, the only way to remove the metal stains is to drain the pool and wash the surface with a strong acid such as hydrochloric acid (muriatic), or to add copious amounts of acid into the pool in an attempt to remove the metal stain from the surface. If this acid addition method is successful in pulling the metals from the surface, the metal ions still remain in the water and can once again oxidize and plate out back onto the surface. Therefore, the use of the fill stick device can be placed in the pool and attached to a mechanical pump, such as a sump pump, hence allowing the water to be filtered in the pool and removing the suspended metal ions with the filtering device during the normal operation of the pool pumping system.

Another way of removing metal ions, other inorganic and organic ions from existing pool, spa or aquarium water, is to attach the filtering device as an ‘in-line’ by-pass device in the permanent filtration plumbing lines. This application is employed as a secondary protection method by not only removing metal and other ions from the fill water, but now removing similar contaminants that may enter the pool, spar tub or aquarium water by other means later.

### BRIEF DESCRIPTION OF THE DRAWINGS

Section 1 is a side view of the device.

Section 2 is a cross sectional view of the device.

FIGS. 3 is an exploded view of the device.

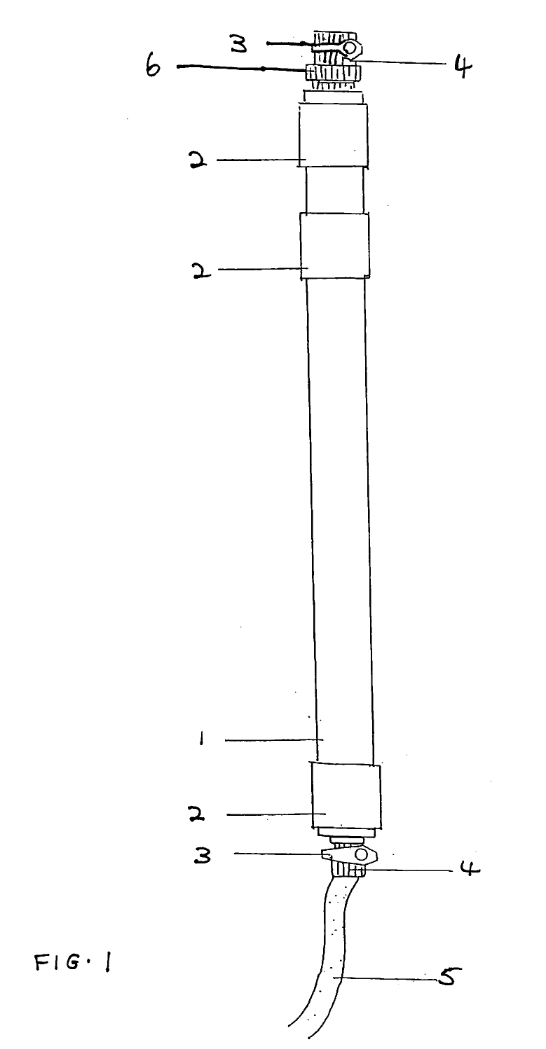

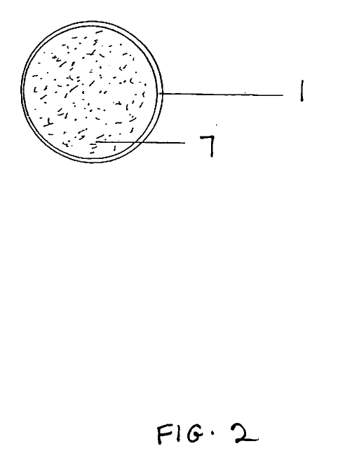

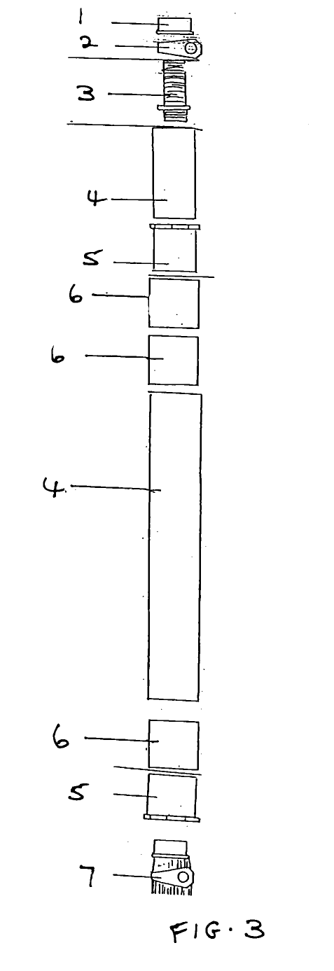

### DETAILED DESCRIPTION OF THE EMBODIMENTS

This device is comprised of a cylindrical tube 1 and is constructed from a plastic of suitable polymer composition such as polyvinyl chloride (PVC) pipe, although different material may be used. FIG. 1 The device is connected to a water source 5 using a connector 4. It is anticipated that garden hose connections will be used for sake of simplicity and convenience.

The water originates from the water source 5 and travels through the hose. The water then passes into the filtering media 7 after passing through a valve 3. The valve 3 will seek to regulate the flow of water into the device. The specific type of valve to be used at the entrance and exit portals of this device will be dependent on the specific needs of the customer. It is anticipated that the type of valve may include ball valves, check valves, or globe valves. The purpose of the valve is to insure that the water enters and exits the device with as little difficulty as possible, without allowing the filtering media to escape from the device.

The water source 5 connections are coupled to the fill stick as depicted in FIG. 1 by couplings, which have been placed on both sides of the device. The specific coupling to be used is not critical to the device as long as the coupling insures water freely flows through the device. Standard garden hose couplings are an example of the coupling that could be used.

At the opposite end of the water entry portal or source 5 the water exits the device through a spout 6, connector 4, and ball valve 3.

It is anticipated that different size filtering sticks will be used depending on the amount of water to be purified.

The specific filtering media will be from the group consisting of the following: various carbons, chloramines, diatomaceous earth, gravel, filtering sands, calcite, calcium carbonates, anthracite, aluminum silicates, zeolites, green manganese, ion exchange resins, among others. The specific formulation or mixture of the filtering media may be altered depending on the specific element to be removed.

Completely filling the interior of the tube 1 is the filtering material, which is the purifying media. All the water that enters the device will pass through the purifying media prior to exiting the device through a diffuser. It is designed to be very lightweight and be manufactured in different shapes and sizes. It is also anticipated that the device will be portable and disposable, if desired.

The purposes of the diffuser is to insure the free flow of water through the device and to insure that the purifying media remains in the tube.

Polyvinyl chloride (PVC) is probably the choice of material because of its durability, weight and relatively low cost. Additionally the filtering stick will be exposed to all Different types of environments, particularly wet areas, and therefore should be made from non-corrosive material.

The purpose of the purifying media is to ensure that the metals, metal ions, other inorganic ions, organic ions, sediment and the hard minerals and other impurities are removed from the water. This device may be used on any type of water regardless of its quality. It is anticipated that different filtering media may be used depending on the particular impurity to be removed. The choice of filtering media will be dependant on the particular set of circumstances in any particular environment. Different types of filtering media will be used for different types of water and the specific type of filtering media will depend on the specific contaminant to be removed.

Additionally, a bleaching chamber or canister may be installed at the exit from the device to bleach the water. This may be particularly important with water sources, which contain high levels of tannin.

1. A cylindrical tube, which is used for purifying water,
which is comprised of:
a. a tube;
b. connectors;
c. valves;
d. couplings;
e. filtering media;
wherein the tube is cylindrical in shape and comes in various lengths and diameters;
wherein a coupling allow the device to be joined to the water source;
wherein an inlet valve controls entry of water into the device;
wherein the filtering media will vary depending on the particular contaminate in the water;
wherein the principal method of removing metals from the water is through ionization;
wherein a diffuser is located at-the exit portal of the device.

2. The device as described in claim l wherein the filtering media is selected from the group consisting of the following: various carbons, chloramines, diatomaceous earth, gravel, filtering sands, calcite, calcium carbonates, anthracite, aluminum silicates, zeolites, green manganese and other ion exchange resins

3. The intake valve as described in claim 1, wherein a ball valve is used.

4. The intake valve as described in claim 1 wherein a check valve is used.

5. The intake valve as described in claim 1 wherein a globe valve is used.

6. The device as described in claim 1 is made from polyvinyl chloride (PVC), polycarbonate, acrylic, polyethylene, polypropylene, polyester or any other polymeric plastic material.

7 The filtration media as described in claim 1 is used to remove or minimize metal ion levels via an ionic exchange filtration.

8. The filtration media as described in claim 1 is used to remove or minimize metal ion levels via an ionic exchange absorption.

9. The filtration media as described in claim 1 is used to remove or minimize metal ion levels via an ionic exchange adsorption.

10. The filter media addition as described in claim 1 is placed in the device in order of particle size for maximum filtration efficiency.

11. The device as described in claim 1 is used as a contaminant filter inside the pool, spa, tub or aquarium to filter removed metal or other ions that already exist in the area of concern.

12. The device as described in claim 1 used as an in-line attachment to the primary filtration system either as a by-passed line unit or sole filtration unit.

13. The device as described in claim 1 or an altered version is used in a bypass line.

14. The filtration media combinations as described in claim 1 are placed as a cartridge filter unit, sand or DE (Diatomaceous earth) filter unit as a primary or secondary filtration source in permanent filtration systems.

15. The device as described in claim 1 may be used in conjunction with an oxidizer chamber at the bottom of the cylindrical filter.

16. The device as described in claim 1 can be used to filter all types of water.

17. The device as described in claim 1 is used to remove or reduce the levels of water contaminants that can impart odors to water such as contaminants, sulfur containing contaminants and others.

18. The device as described in claim 1 is used to remove or reduce levels of water contaminants that can minimize the effectiveness of water sanitizers such as phosphates.
